(19) United States
(12) Patent Application Publication
(10) Pub. No.: US 2018/0154493 A1
(43) Pub. Date: Jun. 7, 2018

(54) METHODS OF EDGE FINISHING LAMINATED GLASS STRUCTURES

(71) Applicant: CORNING INCORPORATED, CORNING, NY (US)

(72) Inventors: DOMINICK JOHN FORENZ, HAMMONDSPORT, NY (US); TIMOTHY DESMOND HARSH, ELMIRA, NY (US); MARK LEE HUMPHREY, BURDETT, NY (US); MICHAEL WILLIAM PRICE, CORNING, NY (US); ERIC JOSEPH TEATOR, CORNING, NY (US); PETER JOSEPH WEBSTER, CORNING, NY (US)

(73) Assignee: Corning Incorporated, Corning, NY (US)

(21) Appl. No.: 15/568,091

(22) PCT Filed: Apr. 22, 2016
(86) PCT No.: PCT/US16/28851

§ 371 Date: Oct. 20, 2017

Related U.S. Application Data
(60) Provisional application No. 62/151,167, filed on Apr. 22, 2015.

(51) Int. Cl. B24B 9/08; C03C 19/00; B32B 3/02; B32B 17/06; B24B 21/00; B24B 23/04; B24D 13/02

(52) U.S. Cl. CPC B24B 9/08; C03C 19/00; B32B 3/02; B32B 2307/412; B24B 21/002; B24B 23/04; B24D 13/02; B32B 17/06

(57) ABSTRACT

A method of finishing a laminated glass structure (102) comprising a flexible glass sheet (130) having a thickness of no greater than about 0.3 mm laminated to a non-glass substrate (116) by an adhesive layer (135) is provided. The method includes applying a compressive force against a cut edge (106) of the flexible glass sheet (130) using an abrasive surface (108) of a hand-held finishing tool (105). Material of the laminated glass structure (102) is removed at the cut edge (106) such that a glass edge strength of the flexible glass sheet (130) is at least about 50 MPa.

This application claims the benefit of priority to U.S. Application No. 62/151,167 filed on Apr. 22, 2015 the content of which is incorporated herein by reference in its entirety.

### FIELD

The present disclosure relates to glass-laminate structures and, more particularly, to methods of finishing laminated glass structures.

### BACKGROUND

Laminated glass structures may be used as components in the fabrication of various appliances, automobile components and architectural structures or electronic devices. For example, laminated glass structures may be incorporated as cover glass for various end products such as refrigerators, backsplashes, decorative glazing or televisions. However, it may be difficult to cut or otherwise shape and finish the laminated glass structures using methods typically used in the field without causing fractures in the glass layer given limitations of the machining and finishing methods that might be used and properties of the laminated glass structures. For example, many such finishing methods are not used to polish glass, plastic or adhesives. Accordingly, there is a need for methods of finish laminated glass structures using finishing methods used in the field to minimize the effort and cost of glass laminate use and installation.

### SUMMARY

One technique to improve the mechanical reliability of flexible glass is to laminate, or bond, the flexible glass to one or more laminate materials or substrates of unique structures. Flexible glass may be glass having a thickness of 300 microns or less, including but not limited to, 300, 275, 250, 225, 200, 190, 180, 170, 160, 150, 140, 130, 120, 110, 100, 90, 80, 70, 60, 50, 40, 30, 20, or 10 microns. Additionally, the flexible glass may have a thickness in a range of from 100 to 200 microns. Depending on the mechanical strength and impact resistance requirements of a laminated glass structure, as well as the expected bending stresses and direction of the intended application, a laminated glass structure can be designed to meet various mechanical requirements. When used properly, the laminated glass structures can offer improved mechanical reliability and impact resistance performance over unlaminated flexible glass.

Once the laminated glass structures are formed, it can become necessary to cut or otherwise shape them. Once cut, in order to achieve a predetermined edge strength, finishing processes may be used to remove undesirable cracks and fractures in the flexible glass layer. To this end, methods of finishing the laminated glass structures are described herein where finishing devices are used to effectively finish the laminated glass structures to desired edge strengths. The laminated glass structures can be used, for example, as a backsplash for kitchen installation, wherein a larger laminated glass structure can be cut down in the field to a preselected size and then edge finished to achieve a predetermined edge strength.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations. By way of non-limiting example the various features of the disclosure may be combined with one another according to the following aspects.

According to a first aspect, a method of finishing a laminated glass structure comprising a flexible glass sheet having a thickness of no greater than about 0.3 mm laminated to a non-glass substrate by an adhesive layer is provided. The method includes applying a compressive force against a cut edge of the flexible glass sheet using an abrasive surface of a hand-held finishing tool. Material of the laminated glass structure is removed at the cut edge such that a glass edge strength of the flexible glass sheet is at least 50 MPa or greater.

According to a second aspect, there is provided the method of aspect 1, wherein the abrasive surface comprises an abrasive material having an ISO/FEPA grit designation of at least 180 or finer.

According to a third aspect, there is provided the method of aspect 1 or aspect 2, further comprising directing a liquid over the cut edge during the step of removing material of the laminated glass structure.

According to a fourth aspect, there is provided the method of any one of aspects 1-3, further comprising positioning the abrasive surface at an angle of between about 1 and about 20 degrees to a plane transverse to a broad surface of the flexible glass sheet during the step of removing material of the laminated glass structure.

According to a fifth aspect, there is provided the method of any one of aspects 1-4, wherein the finishing tool is a sanding block and the abrasive surface is provided by sandpaper.

According to a sixth aspect, there is provided the method of any one of aspects 1-4, wherein the finishing tool is an orbital sander comprising a head that includes the abrasive surface.

According to a seventh aspect, there is provided the method of any one of aspects 1-4, wherein the finishing tool is a belt sander comprising a belt that includes the abrasive surface.

According to an eighth aspect, there is provided the method of any one of aspects 1-4, wherein the finishing tool comprises a compliant sanding ball that includes the abrasive material.

According to a ninth aspect, there is provided the method aspect 8, wherein the compliant sanding ball has a durometer rating of between 20 Shore A and 35 Shore A.

According to a tenth aspect, there is provided the method of any one of aspects 1-4, wherein the finishing tool comprises an inflatable bulb and sanding sleeve carried by the inflatable bulb and including the abrasive material.

According to an eleventh aspect, a method of finishing a laminated glass structure comprising a flexible glass sheet having a thickness of no greater than about 0.3 mm laminated to a non-glass substrate by an adhesive material is provided. The method includes supporting the preform laminated glass structure on a support surface such that the non-glass substrate is located between the flexible glass sheet and the support surface. Material of the laminated glass structure is removed at a cut edge using an abrasive surface of a finishing tool. The abrasive surface is positioned at an angle of between about 1 and about 20 degrees to a plane transverse to a broad surface of the flexible glass sheet during the step of removing material of the laminated glass structure.

According to a twelfth aspect, there is provided the method of aspect 11, wherein the abrasive surface comprises an abrasive material having an ISO/FEPA grit designation of at least 180 or finer.

According to a thirteenth aspect, there is provided the method of aspect 11 or aspect 12, further comprising directing a liquid over the cut edge during the step of removing material of the laminated glass structure.

According to a fourteenth aspect, there is provided the method of any one of aspects 11-13, wherein the finishing tool is a sanding block and the abrasive surface is provided by sandpaper.

According to a fifteenth aspect, there is provided the method of any one of aspects 11-13, wherein the finishing tool is an orbital sander comprising a head that includes the abrasive surface.

According to a sixteenth aspect, there is provided the method of any one of aspects 11-13, wherein the finishing tool is a belt sander comprising a belt that includes the abrasive surface.

According to a seventeenth aspect, there is provided the method of any one of aspects 11-13, wherein the finishing tool comprises a compliant sanding ball that includes the abrasive material.

According to an eighteenth aspect, there is provided the method of aspect 17, wherein the compliant sanding ball has a durometer rating of between 20 Shore A and 35 Shore A.

According to a nineteenth aspect, there is provided the method of any one of aspects 11-13, wherein the finishing tool comprises an inflatable bulb and sanding sleeve carried by the inflatable bulb and including the abrasive material.

According to an twentieth aspect, a method of finishing a laminated glass structure comprising a flexible glass sheet having a thickness of no greater than about 0.3 mm laminated to a non-glass substrate by an adhesive material is provided. The method includes supporting the preform laminated glass structure on a support surface such that the non-glass substrate is located between the flexible glass sheet and the support surface. Material of the laminated glass structure is removed at a cut edge using an abrasive surface of a finishing tool. The abrasive surface of the finishing tool is compliant and resiliently deflects as a compressive force is applied against the cut edge of the flexible glass sheet using the abrasive surface during the step of removing the material of the laminated glass structure.

According to a twenty-first aspect, there is provided the method of aspect 20, wherein the step of removing material of the laminated glass structure at the cut edge is such that a glass edge strength of the flexible glass sheet is at least about 50 MPa.

According to a twenty-second aspect, there is provided the method of aspect 20 or aspect 21, wherein the abrasive surface comprises an abrasive material having an ISO/FEPA grit designation of at least 180 or finer.

According to a twenty-third aspect, there is provided the method of any one of aspects 20-22, further comprising directing a liquid over the cut edge during the step of removing material of the laminated glass structure.

According to a twenty-fourth aspect, there is provided the method of any one of aspects 20-23, wherein the finishing tool is a sanding block and the abrasive surface is provided by sandpaper.

According to a twenty-fifth aspect, there is provided the method of any one of aspects 20-23, wherein the finishing tool is an orbital sander comprising a head that includes the abrasive surface.

According to a twenty-sixth aspect, there is provided the method of any one of aspects 20-23, wherein the finishing tool is a belt sander comprising a belt that includes the abrasive surface.

According to a twenty-seventh aspect, there is provided the method of any one of aspects 20-23, wherein the finishing tool comprises a compliant sanding ball that includes the abrasive material.

According to a twenty-eighth aspect, there is provided the method of aspect 27, wherein the compliant sanding ball has a durometer rating of between 20 Shore A and 35 Shore A.

According to a twenty-ninth aspect, there is provided the method of any one of aspects 20-23, wherein the finishing tool comprises an inflatable bulb and sanding sleeve carried by the inflatable bulb and including the abrasive material.

According to a thirtieth aspect, there is provided the method of any one of aspects 20-29, further comprising positioning the abrasive surface at an angle of no more than about 45 degrees to a plane transverse to a broad surface of the flexible glass sheet during the step of removing material of the laminated glass structure.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 illustrates a cross-sectional view of one embodiment of a laminated glass structure in accordance with aspects of the disclosure;

FIG. 2 depicts a cross-sectional view of the laminated glass structure of FIG. 1 with a decorative pattern located on one or more of the glass surface or upon a film located between the substrate and the flexible glass layer in accordance with aspects of the disclosure;

FIG. 3 illustrates a method of finishing a cut edge of a laminated glass structure in accordance with aspects of the disclosure;

FIG. 4A illustrates a chart of grit particle size versus US diamond grit designation;

FIG. 4B illustrates a chart of average glass chip size versus abrasive particle size;

FIG. 4C illustrates a chart of average glass chip size versus ISO/FEPA grit designation;

FIG. 5 illustrates a finished, cut edge of a laminated glass structure in accordance with aspects of the disclosure;

FIG. 6 illustrates a method of finishing a cut edge of a laminated glass structure in accordance with aspects of the disclosure;

FIG. 7 illustrates another method of finishing a cut edge of a laminated glass structure in accordance with aspects of the disclosure;

FIG. 8 illustrates another method of finishing a cut edge of a laminated glass structure in accordance with aspects of the disclosure;

FIG. 9 illustrates another method of finishing a cut edge of a laminated glass structure in accordance with aspects of the disclosure;

FIG. 9A illustrates a detailed view of area A of FIG. 9;

FIG. 10 illustrates another method of finishing a cut edge of a laminated glass structure in accordance with aspects of the disclosure;

FIG. 11 illustrates another method of finishing a cut edge of a laminated glass structure in accordance with aspects of the disclosure;

FIG. 12 illustrates another method of finishing a cut edge of a laminated glass structure in accordance with aspects of the disclosure;

FIG. 13 illustrates use of a fixture for finishing a cut edge of a laminated glass structure in accordance with aspects of the disclosure; and

FIG. 14 is a schematic illustration of a rotary tool for finishing a cut edge of a laminated glass structure in accordance with aspects of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Although glass is an inherently strong material, its strength and mechanical reliability is a function of its surface defect or flaw size density distribution and the cumulative exposure of stress to the material over time. During an entire product life cycle, a laminated glass structure may be subjected to various kinds of static and dynamic mechanical stresses. Embodiments described herein generally relate to methods of finishing laminated glass structures at an installation location or machining environment. Particular examples may relate to laminated glass structures where the non-glass substrate is a wood, fiberboard, laminate, polymer and/or metal or metal alloy, such as stainless steel, aluminum, nickel, magnesium, brass, bronze, titanium, tungsten, copper, cast iron or a noble metal.

Referring to FIG. 1, a cross-sectional view of an exemplary laminated glass structure 10 is illustrated. The laminated glass structure 10 includes a flexible glass layer 12 that is formed of a flexible glass sheet 14 and a non-glass substrate layer 16 that is laminated to the flexible glass layer 12. The non-glass substrate layer 16 is formed of a non-glass substrate 18, such as polymer, wood or wood-based products such as chipboard, particleboard, fiberboard, and cardboard, hardboard, or low pressure laminate, high pressure laminate, or veneer, or metal or metal alloys such as stainless steel, copper, nickel, brass, bronze, titanium, tungsten, cast iron, aluminum, ceramic, composite, or another polymer or rigid material or combinations of these materials.

The non-glass substrate 18 may be formed using a polymer material, for example, any one or more of polyethylene teraphthalate (PET), polyethylene Naphthalate (PEN), ethylene tetrafluoroethylene (ETFE), or thermopolymer polyolefin (TPO™—polymer/filler blends of polyethylene, polypropylene, block copolymer polypropylene (BCPP), or rubber), polyesters, polycarbonate, polyvinylbuterate, polyvinyl chloride, polyethylene and substituted polyethylenes, polyhydroxybutyrates, polyhydroxyvinylbutyrates, polyetherimides, polyamides, polyethylenenaphalate, polyimides, polyethers, polysulphones, polyvinylacetylenes, transparent thermoplastics, transparent polybutadienes, polycyanoacrylates, cellulose-based polymers, polyacrylates and polymethacrylates, polyvinylalcohol, polysulphides, polyvinyl butyral, polymethyl methacrylate and polysiloxanes. It is also possible to use polymers which can be deposited/coated as pre-polymers or pre-compounds and then converted, such as epoxy-resins, polyurethanes, phenol-formaldehyde resins, and melamine-formaldehyde resins. Many display and electrical applications may prefer acrylic based polymers, silicones and such structural aiding layers, for example, commercially available SentryGlas® from DuPont. The polymer layers may be transparent for some applications, but need not be for other applications.

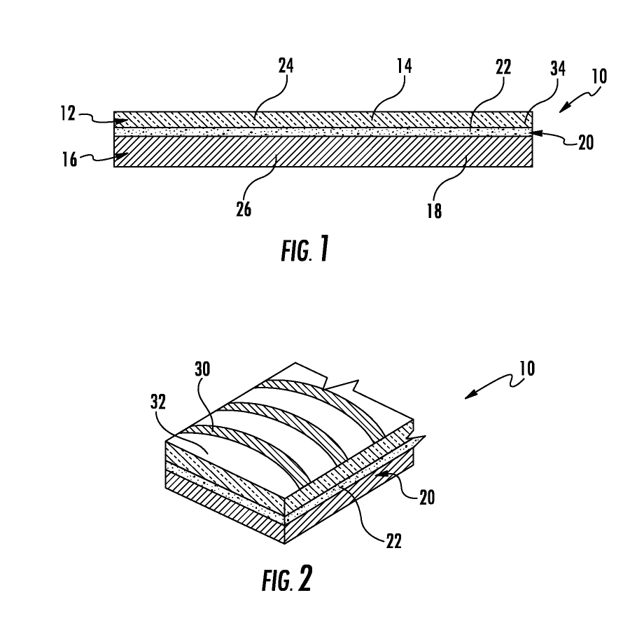

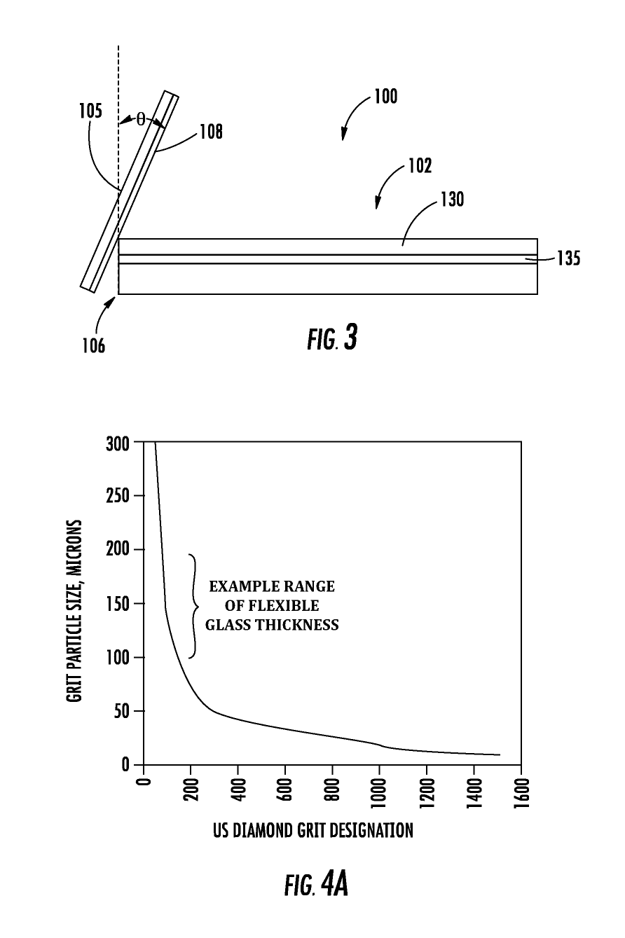

An adhesive layer 20 may be formed of an adhesive material 22 that may be used to laminate the flexible glass layer 12 to the non-glass substrate layer 16 at the interfaces between their respective broad surfaces 24 and 26. The adhesive material 22 may be a non-adhesive interlayer, an adhesive, a sheet or film of adhesive, a liquid adhesive, a powder adhesive, a pressure sensitive adhesive, an ultraviolet-light curable adhesive, a thermally curable adhesive, or other similar adhesive or combination thereof. The adhesive material 22 may assist in attaching the flexible glass 14 to the non-glass substrate 18 during lamination. Some examples of low temperature adhesive materials include Norland 68 cured by UV, Flexcon V29TT, 3M OCA 8211, 8212, 8146, and 8172 (bonded by pressure at room temperature or above), 3M 4905, OptiClear® adhesive, silicones, acrylates, optically clear adhesives, encaptulant material, polyurethane polyvinylbutyrates, ethylenevinylacetates, ionomers, and wood glues. Typical graphic adhesives such as Graphicmount and Facemount may also be used (as available from LexJet Corporation, located in Sarasota Fla., for example). Some examples of higher temperature adhesive materials include DuPont SentryGlas, DuPont PV 5411, Japan World Corporation material FAS and polyvinyl butyral resin. The adhesive layer 20 may be thin, having a thickness less than or equal to about 1000 μm, including less than or equal to about 500 μm, about 250 μm, less than or equal to about 50 μm, less than or equal to 40 μm, less than or equal to about 25 μm, or between about 0.1 mm and about 5 mm. The adhesives may also contain other functional components such as color, decoration, heat or UV resistance, AR filtration etc. The adhesive material 22 may be optically clear on cure, or may otherwise be opaque. In embodiments where the adhesive material 22 is a sheet or film of adhesive, the adhesive material 22 may have a decorative pattern or design visible through the thickness of the flexible glass, as shown in FIG. 2.

In FIG. 2, the laminated glass structure 10 includes an adhesive layer 20 formed of a sheet or film of adhesive material 22. The adhesive material 22 has a pattern of stripes 30 that are visible from an outer surface 32 of the flexible glass layer 12. In some embodiments, the non-glass substrate layer may provide a decorative pattern and/or the decorative pattern may be provided on either surface of the flexible glass sheet 14. In some embodiments, the decorative pattern may be provided on multiple layers 12, 16 and/or 20. Some air bubbles may become entrained in the laminated glass structure during or after lamination, but air bubbles having a diameter of equal to or less than 100 μm may not affect the impact resistance of the laminated glass structure. Formation of air bubbles may be reduced by use of a vacuum lamination system or application of pressure to a surface of the structure during lamination. In other embodiments, the flexible glass layer 12 may be laminated without adhesive.

The flexible glass sheet 14 may have a thickness 34 of about 0.3 mm or less including but not limited to thicknesses of, for example, about 0.01-0.05 mm, about 0.05-0.1 mm, about 0.1-0.15 mm, about 0.15-0.3 mm, about 0.100 to about 0.200 mm, 0.3, 0.275, 0.25, 0.225, 0.2, 0.19, 0.18, 0.17, 0.16, 0.15, 0.14, 0.13, 0.12, 0.11, 0.10, 0.09, 0.08 0.07, 0.06, 0.05, 0.04, 0.03, 0.02, or 0.01 mm. The flexible glass sheet 14 may be formed of glass, a glass ceramic, a ceramic material or composites thereof. A fusion process (e.g., downdraw process) that forms high quality flexible glass sheets can be used in a variety of devices and one such application is flat panel displays. Glass sheets produced in a fusion process have surfaces with superior flatness and smoothness when compared to glass sheets produced by other methods. The fusion process is described in U.S. Pat. Nos. 3,338,696 and 3,682,609. Other suitable glass sheet forming methods include a float process, updraw and slot draw methods. Additionally, the flexible glass sheet 14 may also contain anti-microbial properties by using a chemical composition for the glass including an Ag ion concentration on the surface in the range greater than 0 to 0.047 μg/cm², further described in U.S. Patent Application Publication No. 2012/0034435 A1. The flexible glass 14 may also be coated with a glaze composed of silver, or otherwise doped with silver ions, to gain the desired anti-microbial properties, as further described in U.S. Patent Application Publication No. 2011/0081542 A1. Additionally, the flexible glass 14 may have a molar composition of 50% SiO₂, 25% CaO, and 25% Na₂O to achieve the desired anti-microbial effects.

Once the flexible glass sheet 14 is formed, it may be laminated to the non-glass substrate 18 using a variety of apparatus and processes. Some examples include sheet-to-sheet lamination where pressure and/or heat are used to bond the flexible glass sheet 14 to the non-glass substrate 18, for example, using the adhesive material 22. As another example, a roll-to-sheet or roll-to-roll lamination method may be used where; again, pressure is used to bond a continuous ribbon of flexible glass sheet 14 from a supply roll to a non-glass substrate 18 either as a continuous substrate from a supply roll or a plurality of individual substrates. While it may be possible to form the laminated glass structure to a final, desired dimension, it may be the case that some type of shaping (e.g., cutting) of the laminated glass structure will be needed after the laminated glass structure is formed. In these instances, the laminated glass structure may be referred to as a preform laminated glass structure in that the preform laminated glass structure will undergo final processing in the field, for example, at an installation site to desired dimensions.

Without wishing to be bound by theory, one difficulty that may be encountered during cutting of the laminated glass structures to a predetermined dimension is maintaining an acceptable edge quality of the flexible glass sheet 14. Edge quality of the flexible glass sheet 14 is related to edge strength and the possibility of initiation/formation of undesirable or unintended cracks and fractures in the flexible glass sheet 14. As used herein, “edge strength” refers to the strength of a flexible glass sheet of a laminated glass structure determined using a modified procedure based on the procedure described in ASTM C-158 “Standard Test Methods for Strength of Glass by Flexure (Determination of Modulus of Rupture),” which is incorporated herein by reference in its entirety. The modified procedure is generally the same as the procedure described in ASTM C-158, except for an additional calculation performed to determine the glass strength. The modified procedure includes determining a load vs. glass stress calibration curve for the laminated glass structure using one of the following methods: 1) directly measuring the strain in the flexible glass sheet (e.g., by a strain gauge) at multiple loads and then calculating stress in the flexible glass sheet at the multiple loads using its elastic modulus, 2) directly measuring the stress in the flexible glass sheet (e.g., by a stress optical method) at multiple loads, or 3) beam theory analysis of the laminated glass structure, which may be difficult due to uncertainties in the adhesive properties. The laminated glass structure is tested using the procedure described in ASTM C-158 to determine the load at which the flexible glass sheet (as opposed to the complete laminated glass structure) fails, and the calibration curve is used to translate the determined failure load into a glass stress value, which is reported as the glass strength. In some embodiments, it may be desirable to maintain a predetermined edge strength in the flexible glass sheet 14 after cutting and an even higher predetermined edge strength after edge finishing the flexible glass sheet 14. For example, maintaining an edge strength in the flexible glass sheet 14 of at least about 50 MPa can allow the flexible glass sheet 14 of the laminated glass structure 10 to survive end use conditions, such as handling and installation, without forming cracks and fractures in the flexible glass sheet 14. However, specialized tools for cutting and finishing the flexible glass sheet 14 are generally not available in manufacturing and installation environments. It has been found that, under predetermined conditions, finishing methods and equipment that are not typically used for at least one of the materials in the laminated glass structure can be used to finish the laminated glass structures 10 (e.g., flexible glass sheet 14, adhesive material 22 and non-glass substrate 18), and, in some embodiments, can maintain or provide a predetermined edge strength of at least about 50 MPa, such as at least about 70 MPa in the flexible glass sheets 14.

Referring to FIG. 3, a multi-step method 100 of finishing a preform laminated glass structure 102 using a finishing tool such as sanding block 105 is illustrated. In some embodiments, the preform laminated glass structure 102 may be formed using a suitable cutting tool such as an abrasive wheel of a grinding machine, abrasive wheel and/or a metal wire electrode using a wire electrical discharge machine (WEDM). As used herein, the term “cutting tool” refers to any cutting tool suitable for removing glass material from the preform laminated glass structure without causing significant damage so as to be able to achieve edge strengths in the flexible glass sheets of at least about 50 MPa before or after any edge finishing as described herein. In some embodiments, the sanding block 105 may be formed of a compliant material, such as a pad or foam material. As used herein, a “compliant material” refers to a material that is flexible and resiliently deforms under suitable processing pressures, such as would be applied manually.

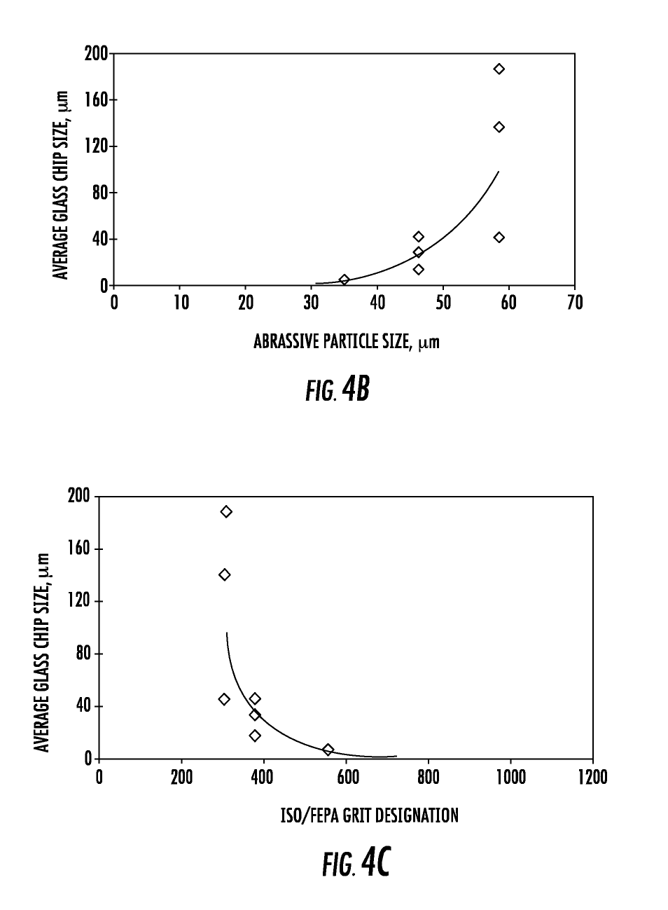

FIG. 3 illustrates a cut edge 106 of the preform laminated glass structure 102. Due to the cutting process, rounded and/or straight chips may be created along the cut edge 106. In some embodiments, a finishing operation or multiple finishing operations may be desired to remove or reduce the size of the chips and create a smoother or cleaner cut edge. A suitable sandpaper 108 (e.g., ALOx, SiC; at least 180 grit or finer, such as 320 grit or finer) is attached to a sanding block 105. The sandpaper 108 has an abrasive side with an abrasive portion and may have a smooth (non-abrasive) side with a non-abrasive portion facing the sanding block 105. In other embodiments, both sides of the sandpaper 108 may have an abrasive material. Referring briefly to FIGS. 4A-4C, charts comparing grit size to flexible glass sheet thickness and glass chip sizes are illustrated. To minimize glass edge chipping during either a cutting or finishing operation, the grit size used should be much smaller than the thickness of the flexible glass sheet to produce any chip sizes less than a predetermined depth (e.g., about 20 μm or less). In some embodiments, grit sizes of 400 or finer, such as 600 or finer, such as 800 or finer may be used. A shown in FIG. 4A, when a flexible glass thickness of 100 to 200 microns is used, a grit size of 600 produces a grit particle size of less than 50 microns, i.e., about 30 microns and much smaller than the thickness of the flexible glass. For example, using abrasive particles during the finishing process having an average diameter of less than about ¼, such as less than about ⅕ of the thickness of the flexible glass sheet can significantly reduce edge chipping and obtain glass edge strengths of about 50 MPa or more. As shown in FIGS. 4B and 4C, an abrasive grit particle size of 30 microns (from ISO/FEPA Grit Designation 600) produces negligible average glass chip sizes.

Referring back to FIG. 3, a fluid, for example, a sanding fluid such as water may be applied along the cut edge 106. The sandpaper 108 and sanding block 105 may be held at an angle θ (e.g., between about 1 and about 20 degrees) to the cut edge 106 (i.e., at an angle to a plane transverse to the broad surface of the flexible glass sheet). Referring briefly to FIG. 5, such an arrangement can produce an edge 110 of the flexible glass sheet 112 offset inwardly of an edge 114 of the non-glass substrate 116 and can provide some protection for the edge 110, for example, during handling by extending the edge 114 beyond the edge 110. Such a sanding arrangement can also provide a compressive force against the glass sheet 112 during the sanding operation. Referring again to FIG. 3, once the initial sanding operation is complete, e.g., using 180 grit sandpaper or finer, such as 320 grit or finer, a finer grit sandpaper (e.g., 400, 600, 800 grit) may be used at the same angle θ for the finishing operation. It should be noted that while the cut edge 106 is an exterior edge, the sanding block 105 with sandpaper 108 may be used to finish an interior edge (e.g., a cut out edge).

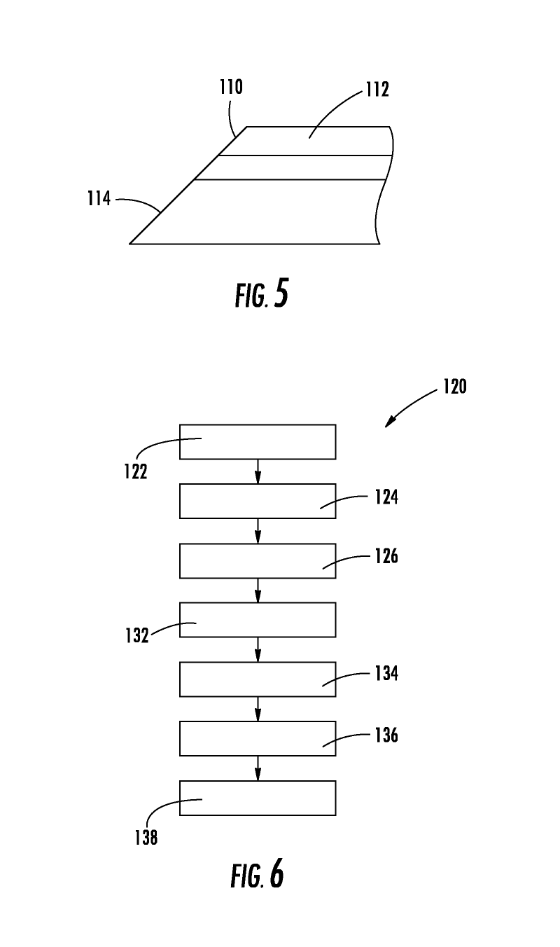

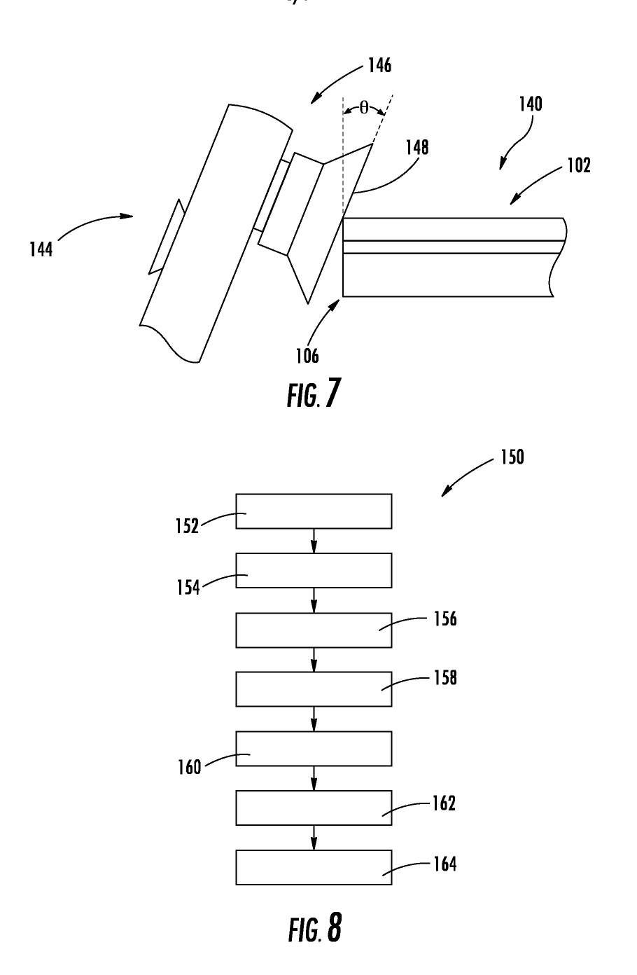

Referring to FIG. 6, a method 120 of finishing the preform laminated glass structure 102 using the sanding block 105 is illustrated. At step 122, a liquid, such as water, is directed over the cut edge 106 of the preform laminated glass structure 102. The liquid may be provided continuously, or, in some embodiments, intermittently to wet the cut edge 106 during the finishing operation. The sanding block 105 with 180 grit or finer (e.g., such as 320 grit or finer) SiC (or AlOx) sandpaper 108 sized to allow manual finger pressure to be applied is provided at step 124. At step 126, using the sanding block 105, the sandpaper 108 may be moved across the cut edge 106 in a top-to-bottom direction with the preform laminated glass structure 102 positioned flexible glass side up. Such a top-to-bottom arrangement can maintain a compressive force against the flexible glass layer 130 (FIG. 3) as the sandpaper 108 is directed over the cut edge 106, removing glass particles and can also reduce the possibility of grinding media embedding in the adhesive layer 135. At step 132, the sandpaper 108 is held at an angle θ to a plane orthogonal to the flat surface of the flexible glass layer 130, thereby maintaining an angle θ of between about 1 and about 20 degrees to the plane. At step 134, sanding is continued with the 180 grit or finer sandpaper 108 until the entire cut edge 106 is finished. At step 136, a finer grit sandpaper (e.g., 400, 600, 800) may be progressively used to finish the entire cut edge 106 until any chips and cracks are removed and a satisfactory edge smoothness is reached. The laminated glass structure may then be cleaned (e.g., rinsed and wiped and dried) at step 138. As one example, time for sanding may be between about 5 to about 10 minutes per grit size depending on the size and condition of the cut edge.

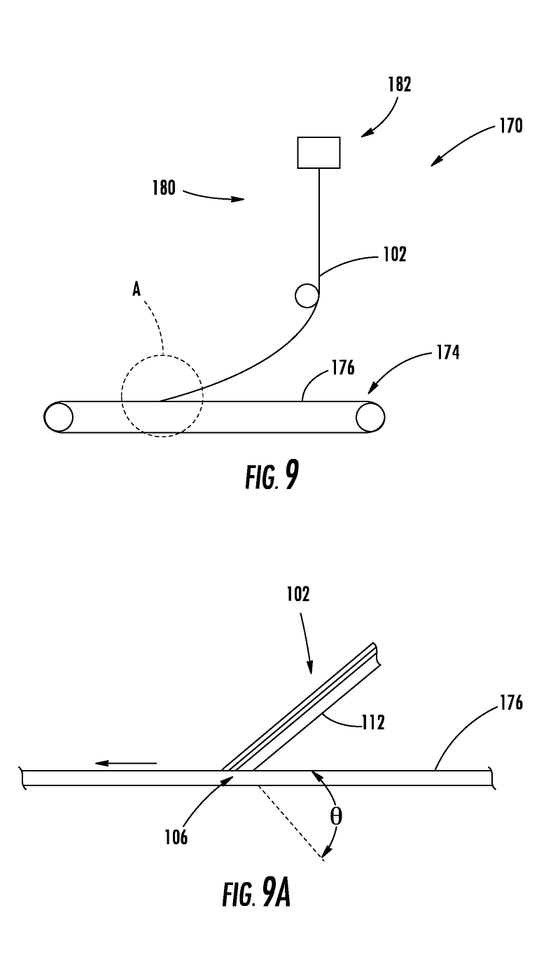

Referring to FIG. 7, another multi-step method 140 of finishing a preform laminated glass structure 102 using a finishing tool such as an orbital sander 144 is illustrated. Orbital sanders may utilize a head 146, which carries abrasive material or sandpaper 148 and is driven rotationally, for example, by a compressed air powered motor. The head 146 may be mounted to a spindle, which in turn may be mounted eccentrically relative to a vertical axis of the motor so that the head 146 orbits about the vertical axis. As above, a fluid, for example, such as water may be applied along the cut edge 106. The sandpaper 148 and head 146 may be held at an angle θ (e.g., between about 1 and about 20 degrees) to the cut edge 106 (i.e., at an angle to a plane transverse to the broad surface of the flexible glass sheet). Referring back to FIG. 5, such an arrangement can produce the edge 110 of the flexible glass sheet 112 offset inwardly of the edge 114 of the non-glass substrate 116. The orbital sander 144 may be capable of a random orbit at a predetermined sanding speed (e.g., about 4,000 orbits per minute) with, for example, 5 or 6 inch sandpaper pads. Referring again to FIG. 7, once the initial sanding operation is complete, e.g., using 180 grit or finer, such as 320 grit or finer sandpaper, a finer grit abrasive material (e.g., 400, 600, 800 grit) may be used at the same angle θ for the finishing operation. It should be noted that while the cut edge 106 is an exterior edge, the sanding block 105 with sandpaper 108 may be used to finish an interior edge (e.g., a cut out edge).

Referring to FIG. 8, a method 150 of finishing the preform laminated glass structure 102 using the orbital sander 144 is illustrated. At step 152, a liquid, such as water, is directed over the cut edge 106 of the preform laminated glass structure 102. The liquid may be provided continuously, or, in some embodiments, intermittently to wet the cut edge 106 during the finishing operation. The head 146 with 320 grit SiC (or AlOx) sandpaper 108 is provided at step 154. At step 156, the sandpaper 108 may be moved across the cut edge 106 in a random orbit with the preform laminated glass structure 102 positioned flexible glass side up. At step 158, the sandpaper 108 is held at an angle θ to a plane orthogonal to the flat surface of the flexible glass layer 130, thereby maintaining an angle θ of between about 1 and about 20 degrees to the plane. At step 160, sanding is continued with the 180 grit or finer sandpaper 108, such as 320 grit or finer until the entire cut edge 106 is finished. At step 162, a finer grit sandpaper (e.g., 400, 600, 800) may be progressively used to finish the entire cut edge 106 until any chips and cracks are removed and a satisfactory edge smoothness is reached. The laminated glass structure may then be cleaned (e.g., rinsed and wiped and dried) at step 164. As one example, time for sanding may be between about 1 to about 2 minutes per grit size depending on the size and condition of the cut edge.

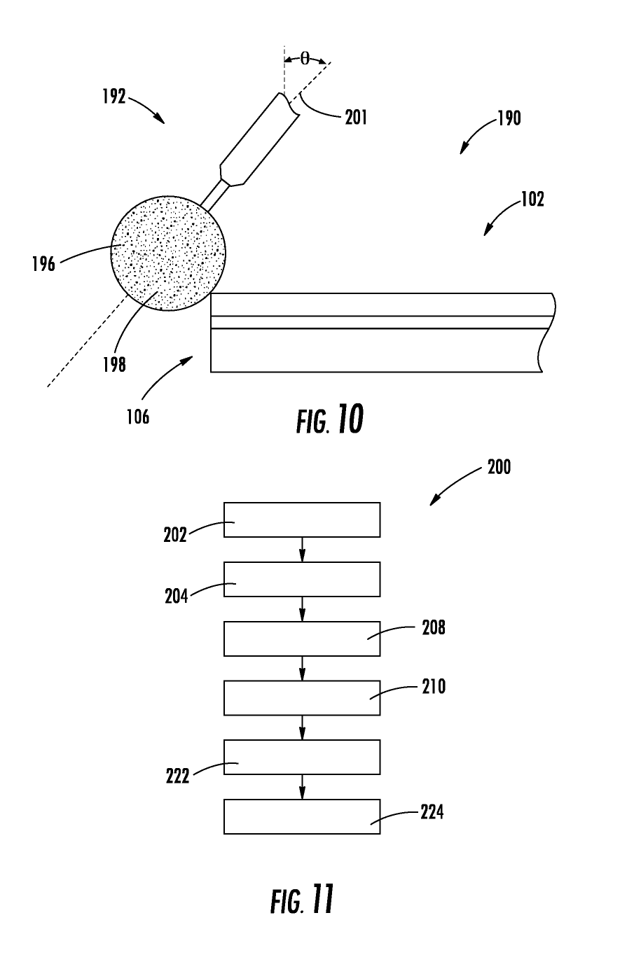

Referring to FIG. 9, another multi-step method 170 of finishing a preform laminated glass structure 102 using a finishing tool such as a belt sander 174 is illustrated. Belt sanders 174 may utilize a belt 176, which carries an abrasive material and is driven in a continuous fashion in a loop, for example, by an electric motor used to drive a pair of drums (e.g., at about 200 rpm or more, such as between about 500 rpm and about 3000 rpm, such as about 1850 rpm). The belt 176 with abrasive material may be held at an angle θ (e.g., between about 1 and about 20 degrees, such as 10 degrees) to the cut edge 106 (i.e., at an angle to a plane transverse to the broad surface of the flexible glass sheet) as shown by FIG. 9A. As shown by FIG. 9A, the flexible glass sheet 112 may be arranged to face the belt 176 during the sanding operation to apply a compressive force to the flexible glass sheet 112. A fixture 180 may be provided for supporting the preform laminated glass structure 102 during the finishing operation. In some embodiments, the fixture 180 may include a conveyor apparatus 182 that moves the preform laminated glass structure 102 relative to the belt 176 (e.g., in a direction transverse to the running direction of the belt 176). Once the initial sanding operation is complete, e.g., using 180 grit adhesive particles or finer such as 320 grit adhesive particles, a finer grit adhesive particles (e.g., 400, 600, 800 grit) may be used at the same angle θ for the finishing operation.

Referring to FIG. 10, another multi-step method 190 of finishing a preform laminated glass structure 102 using a finishing tool such as an abrasive coated compliant finishing ball sander 192 is illustrated. The finishing ball sander 192 may utilize a compliant ball 196, which is coated with an abrasive material 198 and is driven rotationally, for example, by an electric motor. The ball 196 may be mounted to a spindle, which in turn may be rotationally mounted to an axis of the motor so that the compliant ball 196 spins about the axis 201 (e.g., between about 200 and about 500 rpm). The compliant ball 196 may be held at an angle θ (e.g., between about 1 degree and about 20 degrees, such as between about 5 degrees and about 20 degrees, such as about 10 degrees) to the cut edge 106 (i.e., at an angle to a plane transverse to the broad surface of the flexible glass sheet). The compliant ball 196 may also be moved in a compressive rotation direction (as opposed to a climb direction) in order to achieve a compressive force at the leading edge of the compliant ball 196 as it moves along the length of the cut edge 106. Once the initial sanding operation is complete, e.g., using 180 grit abrasive material or finer, such as 320 grit abrasive material, a finer grit abrasive materials (e.g., 400, 600, 800 grit) may be used at the same angle θ for the finishing operation. It should be noted that while the cut edge 106 is an exterior edge, the finishing ball sander 192 with compliant ball 196 may be used to finish an interior edge (e.g., a cut out edge). The laminated glass structure may then be cleaned (e.g., rinsed and wiped and dried). As one example, time for sanding may be between about 1 to about 2 minutes per grit size depending on the size and condition of the cut edge.

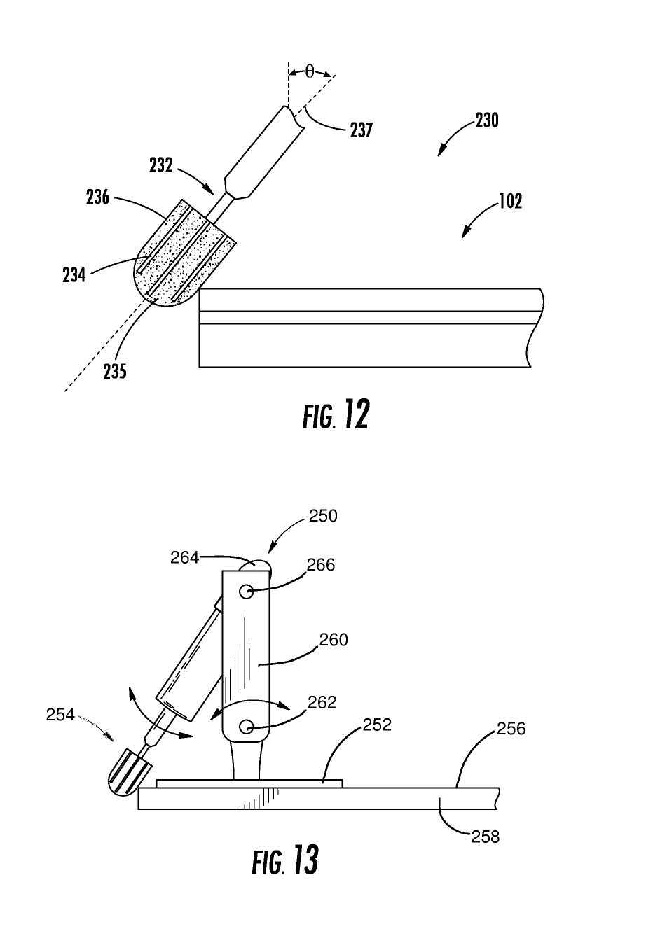

Referring to FIG. 11, a method 200 of finishing the preform laminated glass structure 102 using the abrasive coated compliant finishing ball sander 192 is illustrated. At step 202, a suitable compliant ball 196 with preselected durometer (e.g., between 20 Shore A and 35 Shore A, such as 28 Shore A) rating and coated with a 220 grit abrasive material SiC (or AlOx) is attached to a rotary tool, such as Dremel® tool commercially available from Robert Bosch Tool Corporation, for example. At step 204, the compliant ball 196 may be moved across the cut edge 106 in while rotating (e.g., between about 200 and about 500 rpm) with the preform laminated glass structure 102 positioned flexible glass side up. At step 208, the compliant ball 196 is held at an angle θ to a plane orthogonal to the flat surface of the flexible glass layer 130, thereby maintaining an angle θ of between about 1 and about 20 degrees to the plane. At step 210, sanding is continued with the 180 grit abrasive particles or finer, such as 320 grit abrasive material until the entire cut edge 106 is finished. At step 222, a finer grit abrasive material (e.g., 400, 600, 800) may be progressively used to finish the entire cut edge 106 until any chips and cracks are removed and a satisfactory edge smoothness is reached. The laminated glass structure may then be cleaned (e.g., rinsed and wiped and dried) at step 224. As one example, time for sanding may be between about 1 to about 2 minutes per grit size depending on the size and condition of the cut edge.

Referring to FIG. 12, another multi-step method 230 of finishing a preform laminated glass structure 102 using a finishing tool such as an inflatable cup sander 232 is illustrated. The inflatable cup sander 232 may utilize an inflatable bulb 234 with a sanding sleeve 236 located there around, which is coated with an abrasive material 235 and is driven rotationally, for example, by an electric motor. An exemplary inflatable cup sander is Guinevere®, commercially available from King Arthur's Tools. Any suitable bulb and sleeve size may be used, such as a 2 inch inflatable bulb for straight edge and inside cut-out finishing and a ¾ inch inflatable bulb for corners. The bulb 234 may be mounted to a spindle, which in turn may be rotationally mounted to an axis of the motor so that the inflatable bulb 234 spins about the axis 237 (e.g., between about 200 and about 500 rpm). The inflatable bulb 234 may be held at an angle θ (e.g., between about 1 and about 20 degrees, such as about 10 degrees) to the cut edge 106 (i.e., at an angle to a plane transverse to the broad surface of the flexible glass sheet). The sanding sleeve 236 and inflatable bulb 234 may also be moved in a compressive rotation direction (as opposed to a climb direction) in order to achieve a compressive force at the leading edge of the sanding sleeve 236 as it moves along the length of the cut edge 106. Once the initial sanding operation is complete, e.g., using 180 grit abrasive material or finer, such as 320 grit abrasive material, a finer grit abrasive materials (e.g., 400, 600, 800 grit) may be used at the same angle θ for the finishing operation. It should be noted that while the cut edge 106 is an exterior edge, the inflatable cup sander 232 may be used to finish an interior edge (e.g., a cut out edge). The laminated glass structure may then be cleaned (e.g., rinsed and wiped and dried). As one example, time for sanding may be between about 1 to about 2 minutes per grit size for corner finishing and between about 3 and about 4 minutes per grit size for straight sides depending on the size and condition of the cut edge.

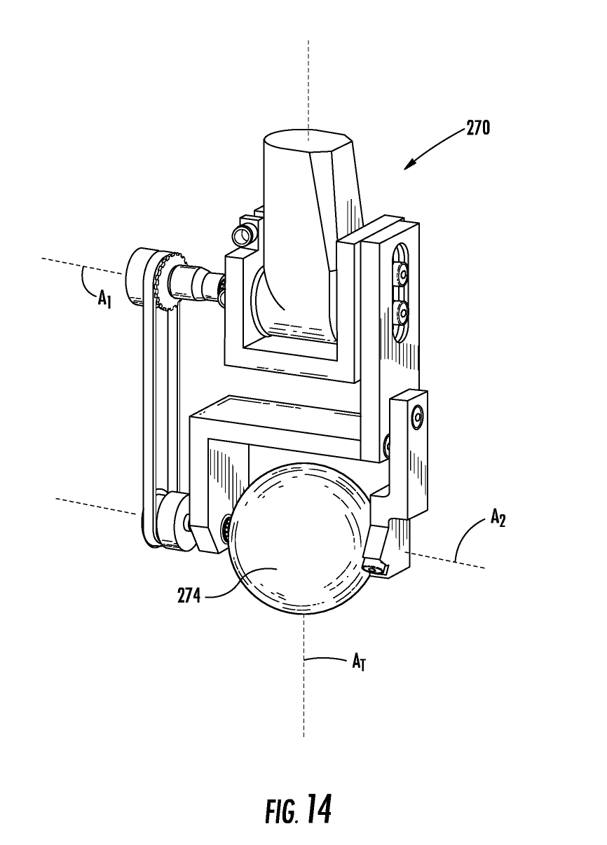

Referring to FIG. 13, in the sanding operations described above, maintaining a preselected angle of the finishing tool and cut edge of the flexible glass substrate in a highly controllable fashion may be desired. To this end, a fixture 250 may be desired that can be used to hold and orient the finishing tool at the desired angle. In this embodiment, the fixture 250 may include a base 252 that may support the finishing tool 254 on a broad surface 256 of a flexible substrate 258. The fixture 250 may include a first rotatable support 260 rotatably connected to the base 252 at a first pivot location 262 and a second rotatable support 264 rotatably connected to the first rotatable support 260 at a second pivot location 266. In some embodiments, the first and second rotatable supports 260 and 264 may inhibit movement relative to each other and the base 252, for example, through a frictional or lockable engagement therebetween to maintain a desired finishing angle.

Referring now to FIG. 14, in some embodiments, an available rotary tool may have a working axis that is perpendicular to a long axis of the rotary tool. In FIG. 14, for example, the rotary tool 270 has a working axis A₁ that is perpendicular to an elongated tool axis A_{T} (which may be a motor axis). Such an arrangement can present challenges in maintaining a desired finishing angle and movement of the rotary tool depending on finishing conditions. In this example, a second rotary axis A₂ is provided that is parallel to the first rotary axis A₁, and a compliant finishing ball 274 is placed in-line with the tool axis A_{T} at a connection location different from that provided by axis A₁. Such an arrangement can facilitate a top-to-bottom motion of the compliant finishing ball moving from the flexible glass sheet downward to the non-glass substrate to maintain a compressive force on the flexible glass sheet.

The systems and methods of finishing laminated glass structures described above allow for use of manufacturing-based finishing methods and machines, such as rotary tools and compliant finishing equipment, while maintaining edge strengths of the flexible glass sheets of at least about 50 MPa, such as about 70 MPa. While manual finishing is described primarily above, other automated tools may be used such as a computerized numerical control (CNC) machine, which can utilize one or more of the sanding structures or variations thereon suitable for use with a CNC machine. The flexible glass sheets can be maintained in compression throughout the finishing process and a finishing angle can be maintained to achieve acceptable edge strength. The finishing systems and methods facilitate repair of any damage flexible glass sheets and maintain life expectance of the flexible glass laminate. Finishing operations can be conducted in the field or manufacturing environment where cutting of the flexible glass laminates may take place.

Although the laminated glass structure 10 is described herein as comprising a single flexible glass sheet 14 laminated to the non-glass substrate 18, other embodiments are included in this disclosure. In some embodiments, the laminated glass structure comprises a second flexible glass sheet laminated to the non-glass substrate. For example, the second flexible glass sheet can be laminated to a second broad surface of the non-glass substrate opposite the first flexible glass sheet. The second flexible glass sheet can be laminated to the non-glass substrate as described herein with respect to the first flexible glass sheet, and one or more edges of the second flexible glass sheet can be finished using the processes described herein with respect to the first flexible glass sheet.

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and the present disclosure and protected by the following claims.

1. A method of finishing a laminated glass structure comprising a flexible glass sheet having a thickness of no greater than about 0.3 mm laminated to a non-glass substrate by an adhesive layer, the method comprising:
applying a compressive force against a cut edge of the flexible glass sheet using an abrasive surface of a hand-held finishing tool; and
removing material of the laminated glass structure at the cut edge such that a glass edge strength of the flexible glass sheet is at least about 50 MPa.

2. The method of claim 1, wherein the abrasive surface comprises an abrasive material having an ISO/FEPA grit designation of 180 or finer.

3. The method of claim 1 further comprising directing a liquid over the cut edge during the step of removing material of the laminated glass structure.

4. The method of claim 1 further comprising positioning the abrasive surface at an angle of no more than about 20 degrees to a plane transverse to a broad surface of the flexible glass sheet during the step of removing material of the laminated glass structure.

5. The method of claim 1, wherein the finishing tool is a sanding block and the abrasive surface is provided by sandpaper.

6. The method of claim 1, wherein the finishing tool is an orbital sander comprising a head that includes the abrasive surface.

7. The method of claim 1, wherein the finishing tool is a belt sander comprising a belt that includes the abrasive surface.

8. The method of claim 1, wherein the finishing tool comprises a compliant sanding ball that includes the abrasive material.

9. The method of claim 8, wherein the compliant sanding ball has a durometer of between of about 20 Shore A to about 35 Shore A.

10. The method of claim 1, wherein the finishing tool comprises an inflatable bulb and a sanding sleeve carried by the inflatable bulb and including the abrasive material.

11. A method of finishing a laminated glass structure comprising a flexible glass sheet having a thickness of no greater than about 0.3 mm laminated to a non-glass substrate by an adhesive material, the method comprising:
supporting the laminated glass structure on a support surface such that the non-glass substrate is located between the flexible glass sheet and the support surface;
removing material of the laminated glass structure at a cut edge using an abrasive surface of a finishing tool; and
positioning the abrasive surface at an angle of no more than about 20 degrees to a plane transverse to a broad surface of the flexible glass sheet during the step of removing material of the laminated glass structure.

12-13. (canceled)

14. The method of claim 11, wherein the finishing tool is a sanding block and the abrasive surface is provided by sandpaper.

15. The method of claim 11, wherein the finishing tool is an orbital sander comprising a head that includes the abrasive surface.

16. The method of claim 11, wherein the finishing tool is a belt sander comprising a belt that includes the abrasive surface.

17. The method of claim 11, wherein the finishing tool comprises a compliant sanding ball that includes the abrasive material, and the compliant sanding ball has a durometer of about 20 Shore A to about 35 Shore A.

18. (canceled)

19. The method of claim 11, wherein the finishing tool comprises an inflatable bulb and a sanding sleeve carried by the inflatable bulb and including the abrasive material.

20. A method of finishing a laminated glass structure comprising a flexible glass sheet having a thickness of no greater than about 0.3 mm laminated to a non-glass substrate by an adhesive material, the method comprising:
supporting the laminated glass structure on a support surface such that the non-glass substrate is located between the flexible glass sheet and the support surface; and
removing material of the laminated glass structure at a cut edge using an abrasive surface of a finishing tool;
wherein the abrasive surface of the finishing tool is compliant and resiliently deflects as a compressive force is applied against the cut edge of the flexible glass sheet using the abrasive surface during the step of removing the material of the laminated glass structure.

21. The method of claim 20, wherein the step of removing material of the laminated glass structure at the cut edge is such that a glass edge strength of the flexible glass sheet is at least about 50 MPa.

22-23. (canceled)

24. The method of claim 20, wherein at least one of:
the finishing tool is a sanding block and the abrasive surface is provided by sandpaper;
the finishing tool is an orbital sander comprising a head that includes the abrasive surface; or
the finishing tool is a belt sander comprising a belt that includes the abrasive surface.

25-26. (canceled)

27. The method of claim 20, wherein the finishing tool comprises a compliant sanding ball that includes the abrasive material, and the compliant sanding ball has a durometer of about 20 Shore A to about 35 Shore A.

28. (canceled)

29. The method of claim 20, wherein the finishing tool comprises an inflatable bulb and a sanding sleeve carried by the inflatable bulb and including the abrasive material.

30. The method of claim 20 further comprising positioning the abrasive surface at an angle of no more than about 20 degrees to a plane transverse to a broad surface of the flexible glass sheet during the step of removing material of the laminated glass structure.
